(19) United States
(12) Patent Application Publication
(10) Pub. No.: US 2020/0057457 A1
(43) Pub. Date: Feb. 20, 2020

(54) METHOD OF GENERATING CONTROLLED FLOW EVENT IN PIPES TO REGULATE HYDRAULIC CONDITIONS

(71) Applicants: HENRY M. HALIMI, Los Angeles, CA (US); Jeffrey A. Scilingo, Rancho Palos Verdes, CA (US); David E. Featherstone, Los Angeles, CA (US)

(72) Inventors: HENRY M. HALIMI, Los Angeles, CA (US); Jeffrey A. Scilingo, Rancho Palos Verdes, CA (US); David E. Featherstone, Los Angeles, CA (US)

(21) Appl. No.: 16/540,482

(22) Filed: Aug. 14, 2019

Related U.S. Application Data
(60) Provisional application No. 62/718,675, filed on Aug. 14, 2018.

(51) Int. Cl. G05D 7/06; G08B 21/18; G08B 3/10

(52) U.S. Cl. CPC G05D 7/0676; G05D 7/0623; E03D 1/26; G08B 3/10; G08B 21/182

(57) ABSTRACT

A device for generating a controlled flow event to regulate a hydraulic condition of a piping system of a building is an electrically-powered fluid pump or fluid valve, having a fluid inlet and fluid outlet. The fluid inlet is configured to be in fluidic communication with a tank of a toilet or is supplied water from the piping system of the building. The fluid outlet is in fluidic communication with either: i) a bowl of the toilet; ii) an overflow tube of the toilet tank; or iii) the tank of the toilet; iv) or a drain. An electronic controller controls the operation of the device and is configured to repeatedly turn on and off the electrically-powered fluid pump for a predetermined elapsed time when the hydraulic condition is identified. The hydraulic condition may be a potential freezing condition or an overly high pressure of the piping system of the building.

### CROSS-REFERENCE TO RELATED APPLICATIONS

This application claims priority to the provisional application 62/718,675 filed on Aug. 14, 2018, the entire contents of which are hereby incorporated in full by this reference.

### DESCRIPTION

### Field of the Invention

The present invention generally relates to preventing water pipes from freezing. More particularly, the present invention relates to using a toilet to create a flow condition that can prevent pipes from freezing and regulate other hydraulic conditions.

### Background of the Invention

In various cold climates, the water pipes providing water to a residence or building may freeze. This freezing of the water pipes can cause notable damage and displacement due to pipe bursts and/or leaks. Millions of homes every year suffer from bursts due to sudden flash-freeze conditions in temperate climates or lower than normal conditions in traditional sub-freezing climates.

The most common and effective way to prevent pipes from freezing is to generate flow in the pipes. Traditionally a faucet in the building is left dripping to produce movement of the water in the upstream portion of the pipes. While this can work, in buildings that are not occupied (e.g. vacation homes, etc.) this method wastes a lot of water because the water runs for a long time irrespective of weather conditions. Furthermore, in extreme conditions and depending on the size of the drip, it may not be totally effective. Water in pipes start freezing from the wall of the pipe as the frozen portion of the water increasingly moves towards the inside of the pipe until all the water inside the pipe is fully frozen. Therefore, the downstream drip may not be sufficient for the intensity of the freezing temperatures and the pipe can still totally freeze thereby causing substantial damage.

Beyond the problem of freezing water pipes, other situations may occur that create elevated hydraulic pressure in water systems which again puts strain on system components of the plumbing resulting in reduced service life for these system components. In certain instances, a high pressure event can lead to a burst of pipes, fittings or fixtures. High pressure can be caused directly by failure of various pressure-regulating equipment such as a pressure reducing valve, a thermal expansion tank or a pressure-relief valve. As previously taught, high pressure can also be caused indirectly by freezing conditions.

Accordingly, there is a need for a better and more practical solution of preventing freezing pipes and/or preventing/mitigating various high-pressure events. The present invention fulfills these needs and provides other related advantages.

### SUMMARY OF THE INVENTION

An exemplary embodiment of the present invention includes a method of generating a controlled flow event of a piping system of a building to regulate a hydraulic condition of the piping system, the method comprising the steps of: providing an electrically-powered fluid pump having a fluid inlet and a fluid outlet, the electrically-powered fluid pump configured to move a fluid from the fluid inlet to the fluid outlet; providing an electronic controller in electrical communication with the electrically-powered fluid pump, the electronic controller configured to control the operation of the electrically-powered fluid pump, wherein the electronic controller receives an electrical power from an electric cord configured to be plugged into an electrical system of the building, or, wherein the electronic controller receives the electrical power from a battery that is associated with the electronic controller; installing the fluid inlet of the electrically-powered fluid pump to be in fluidic communication with a tank of a toilet; and installing the fluid outlet of the electrically-powered fluid pump to be in fluidic communication with either: i) a bowl of the toilet, wherein the bowl of the toilet is in fluidic communication with a drainage system of the building; ii) an overflow tube of the tank of the toilet, wherein the overflow tube is in fluidic communication with the bowl of the toilet; or iii) a drain of the piping system of the building; wherein the electronic controller is configured to repeatedly turn on and off the electrically-powered fluid pump to run for a predetermined elapsed time or volume displacement when the hydraulic condition is identified.

The hydraulic condition may be a potential freezing condition of the piping system of the building.

The hydraulic condition may be an overly high pressure of the piping system of the building.

The electronic controller may be configured to receive a wireless communication from an external electronic device.

The external electronic device may be a desktop computer, a laptop computer, a mobile electronic device, a centralized server or a temperature sensor.

The external electronic device may be configured to send the wireless communication to the electronic controller when a local weather condition of the building could result in a potential freezing condition of the piping system.

The external electronic device may be configured to monitor a pressure of the piping system.

The external electronic device may be configured to send the wireless communication to the electronic controller when the hydraulic condition is an overly high pressure of the piping system of the building.

The electronic controller may include and may be in electrical communication with an audible alarm configured to produce an alarm sound when a low battery condition is detected from the battery.

The electrically-powered fluid pump may be configured to be submersible and may be disposed within the tank of the toilet.

The electrically-powered fluid pump may be disposed outside the tank of the toilet.

Another exemplary embodiment of the present invention includes a method of generating a controlled flow event of a piping system of a building to regulate a hydraulic condition of the piping system, the method comprising the steps of: providing an electrically-controlled fluid valve having a fluid inlet, a first fluid outlet and a second fluid outlet, wherein the fluid inlet is configured to be fluidic communication with a fluid supply of the piping system of the building, and wherein a valve disposed within the fluid valve controls the flow to the first fluid inlet, and wherein the second fluid outlet is configured to be constant fluid communication with the fluid inlet; providing an electronic controller in electrical communication with the electrically-controlled fluid valve, the electronic controller configured to control the operation of the electrically-controlled fluid valve, wherein the electronic controller receives an electrical power from an electric cord configured to be plugged into an electrical system of the building, or, wherein the electronic controller receives the electrical power from a battery that is associated with the electronic controller; installing the fluid inlet of the electrically-controlled fluid valve to be in fluidic communication with the fluid supply of the piping system of the building; and installing the fluid outlet of the electrically-powered fluid valve to be in fluidic communication with either: i) a bowl of the toilet, wherein the bowl of the toilet is in fluidic communication with a drainage system of the building; ii) an overflow tube of the tank of the toilet, wherein the overflow tube is in fluidic communication with the bowl of the toilet; iii) the tank of the toilet, the tank having the overflow tube; or iv) a drain of the piping system of the building; wherein the electronic controller is configured to repeatedly turn on and off the electrically-controlled fluid valve for a predetermined elapsed time or volume displacement when the hydraulic condition is identified.

The hydraulic condition may be a potential freezing condition of the piping system of the building, or, wherein the hydraulic condition is an overly high pressure of the piping system of the building.

The electronic controller may be configured to receive a wireless communication from an external electronic device, wherein the external electronic device may be a desktop computer, a laptop computer, a mobile electronic device, a centralized server or a temperature sensor.

The external electronic device may be configured to send the wireless communication to the electronic controller when a local weather condition of the building could result in a potential freezing condition of the piping system.

The external electronic device may be configured to monitor a pressure of the piping system, wherein the external electronic device may be configured to send the wireless communication to the electronic controller when the hydraulic condition is an overly high pressure of the piping system of the building.

Another exemplary embodiment of the present invention includes a device for generating a controlled flow event of a piping system of a building to regulate a hydraulic condition of the piping system, the device comprising: an electrically-powered fluid pump having a fluid inlet and a fluid outlet, the electrically-powered fluid pump configured to move a fluid from the fluid inlet to the fluid outlet; wherein the fluid inlet of the electrically-powered fluid pump is configured to be in fluidic communication with a tank of a toilet; wherein the fluid outlet of the electrically-powered fluid pump is configured to be in fluidic communication with either: i) a bowl of the toilet, wherein the bowl of the toilet is in fluidic communication with a drainage system of the building; ii) an overflow tube of the tank of the toilet, wherein the overflow tube is in fluidic communication with the bowl of the toilet; or iii) a drain of the piping system of the building; an electronic controller in electrical communication with the electrically-powered fluid pump, the electronic controller configured to control the operation of the electrically-powered fluid pump; wherein the electronic controller is configured to receive an electrical power from an electric cord configured to be plugged into an electrical system of the building, or, wherein the electronic controller is configured to receive the electrical power from a battery that is associated with the electronic controller; wherein the electronic controller is configured to repeatedly turn on and off the electrically-powered fluid pump for a predetermined elapsed time or volume displacement when the hydraulic condition is identified.

The electronic controller may be configured to receive a wireless communication from an external electronic device, wherein the external electronic device may be a desktop computer, a laptop computer, a mobile electronic device, a centralized server or a temperature sensor.

The external electronic device may be configured to send the wireless communication to the electronic controller when a local weather condition of the building could result in a potential freezing condition of the piping system.

The external electronic device may beconfigured to monitor a pressure of the piping system, wherein the external electronic device may be configured to send the wireless communication to the electronic controller when the hydraulic condition is an overly high pressure of the piping system of the building.

The electronic controller may include a fill detection sensor configured to monitor a height of the fluid in the tank.

The device may include a water flow sensor in electrical communication with the electronic controller, wherein the water flow sensor may be configured to determine a water flow in a fill tube for the overflow tube of the toilet.

Another exemplary embodiment of the present invention includes a device for generating a controlled flow event of a piping system of a building to regulate a hydraulic condition of the piping system, the device comprising: an electrically-controlled fluid valve having a fluid inlet, a first fluid outlet and a second fluid outlet; wherein a valve disposed within the electrically-controlled fluid valve controls the fluid flow to the first fluid inlet; wherein the second fluid outlet is configured to be constant fluid communication with the fluid inlet; wherein the first fluid inlet is configured to installed to be in fluidic communication with a fluid supply of the piping system of the building; wherein the first fluid outlet of the electrically-powered fluid valve is configured to be installed to be in fluidic communication with either: i) a bowl of the toilet, wherein the bowl of the toilet is in fluidic communication with a drainage system of the building; ii) an overflow tube of the tank of the toilet, wherein the overflow tube is in fluidic communication with the bowl of the toilet; iii) the tank of the toilet, the tank having the overflow tube; or iv) a drain of the piping system of the building; an electronic controller in electrical communication with the electrically-controlled fluid valve, the electronic controller configured to control the operation of the electrically-controlled fluid valve; wherein the electronic controller is configured to receive an electrical power from an electric cord configured to be plugged into an electrical system of the building, or, wherein the electronic controller is configured to receive the electrical power from a battery that is associated with the electronic controller; wherein the electronic controller is configured to repeatedly turn on and off the electrically-controlled fluid valve for a predetermined elapsed time or volume displacement when the hydraulic condition is identified.

The electronic controller may be configured to receive a wireless communication from an external electronic device, wherein the external electronic device may be a desktop computer, a laptop computer, a mobile electronic device, a centralized server or a temperature sensor.

The external electronic device may be configured to send the wireless communication to the electronic controller when a local weather condition of the building could result in a potential freezing condition of the piping system.

The external electronic device may be configured to monitor a pressure of the piping system, wherein the external electronic device may be configured to send the wireless communication to the electronic controller when the hydraulic condition is an overly high pressure of the piping system of the building.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a sectional side view taken through a typical toilet;

FIG. 2 is a sectional perspective view taken through the tank of the structure of FIG. 1;

FIG. 3 is a sectional side view taken inside a toilet tank showing an embodiment of the present invention being an externally mounted pump having an outlet routed to the toilet overflow;

FIG. 4 is a sectional side view taken inside a toilet tank of another embodiment of the present invention showing a submersible pump disposed within the toilet tank having an outlet routed to the toilet overflow;

FIG. 5 is a sectional side view taken inside a toilet tank showing another embodiment of the present invention being an externally mounted pump having an outlet routed to the toilet bowl;

FIG. 6 is sectional side view taken inside a toilet tank of another embodiment of the present invention showing a submersible pump disposed within the toilet tank having an outlet routed to the toilet bowl;

FIG. 7 is a sectional side view of another embodiment of the present invention being an externally mounted fluid valve;

FIG. 8 is a sectional side view of another embodiment of the present invention being an internally mounted fluid valve;

FIG. 9A is an embodiment of a piping schematic of the present invention;

FIG. 9B is another embodiment of a piping schematic of the present invention;

FIG. 9C is yet another embodiment of a piping schematic of the present invention;

FIG. 10 is a view of another embodiment of the present invention before being installed within a tank; and

FIG. 11 is a side sectional view of the structure of FIG. 10 now installed within a toilet tank.

### DETAILED DESCRIPTION OF THE PREFERRED EMBODIMENTS

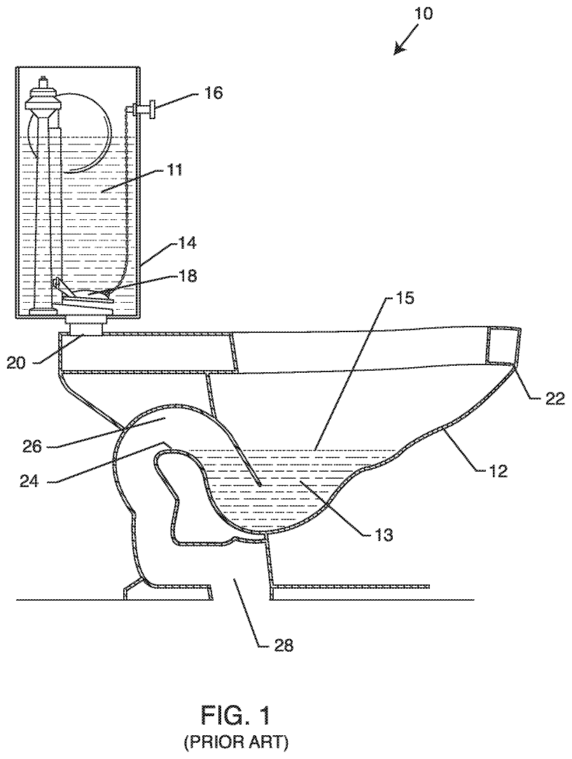

FIG. 1 is a sectional side view taken through a typical toilet 10. The toilet 10 has a bowl 12 that is fed water 11 from a tank 14. The toilet tank 14 receives water from the plumbing system of the building the toilet is located within. When a user presses the trip lever (handle) 16, the flapper valve 18 is opened such that water can rush into the bowl through the inlet 20 and dispose of the waste within the bowl 12 as the water 13 in the bowl empties. It is noted that water 11 flows through the inlet 20 and into a multitude of rim holes 22 disposed around the circumference of the bowl that help provide water all along the entire inner surface of the bowl 12. Water 13 rushing into the bowl rises above the weir 24 such that water passes through the trapway 26 and through the outlet 28. As shown in FIG. 1, one can see that the water level 15 is aligned with the top of the weir 24, but when more water flushes into the bowl the water is able to evacuate out through the outlet 28. It is well known to those skilled in the art of toilets that the shape of the trapway 26 and weir 24 are designed to prevent unpleasant gasses from coming out of the toilet.

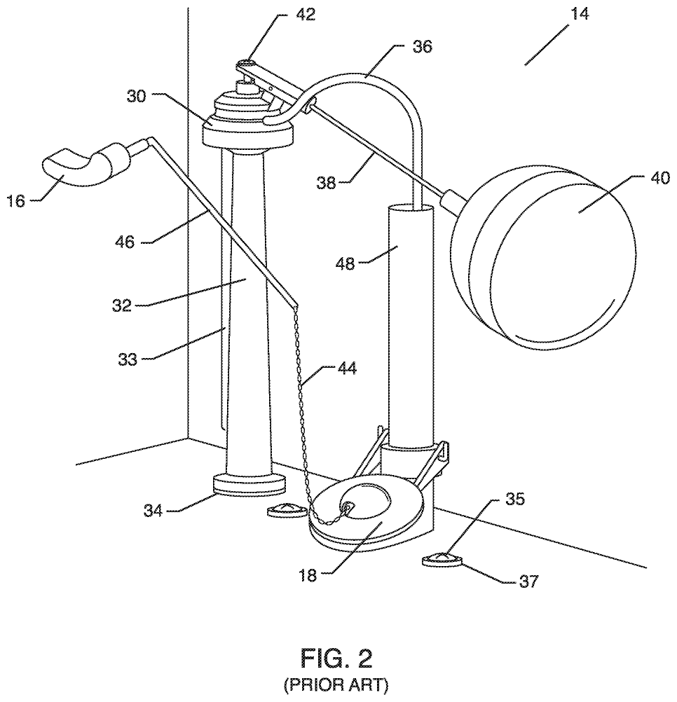

FIG. 2 is a sectional perspective view taken through the tank 14 of FIG. 1 to now see inside which better shows the various parts located inside of the tank. Once water is depleted inside the tank 14, the flapper valve 18 shuts and the tank is refilled. The water from the building enters into the tank and is controlled by the fill valve 30. As shown here, the fill valve 30 is at the top of a pipe extension 32. The bottom of the pipe extension includes a seal 34 to the tank and has a connection on the other side of the tank for the building's water to be connected thereto. Water that passes through the fill valve then exits through a second pipe extension 33 that empties to refill the tank 14. Water also passes through the fill valve and exits through the fill tube 36 to then partially fill the bowl 12. In this manner, two water flows are created after a flush: the first being the water flow to fill the tank and the second being the water flow to fill the bowl.

A float arm 38 is connected at one end to the fill valve 30 and at the other end has a water float 40. The float 40 rises as the water level rises and controls the fill valve 30 to close at a predetermined height. The height can be adjusted by a float adjustment screw 42. In this particular embodiment, there is a chain 44 that connects a handle arm 46 to the handle/trip lever 16. There is also an overflow tube 48 that prevents the tank from overflowing. The overflow tube is also designed to empty into the bowl 12. Any water that rises above the top of the overflow is then routed into the bowl 12 of the toilet 10. In this manner a fill valve that is stuck open cannot overflow the tank 14. Also shown are bolts 35 that attach the tank 14 to the bowl 12. The bolts 35 also have seals 37 to prevent water from escaping the tank.

The particular embodiment of a toilet shown and taught in FIGS. 1 and 2 are very similar to most of the toilets used today. Various parts and features can differ in other variations of the toilet as this teaching is not limited to this exact variation but is representative of how toilets generally work and allows those to now understand the workings of the present invention.

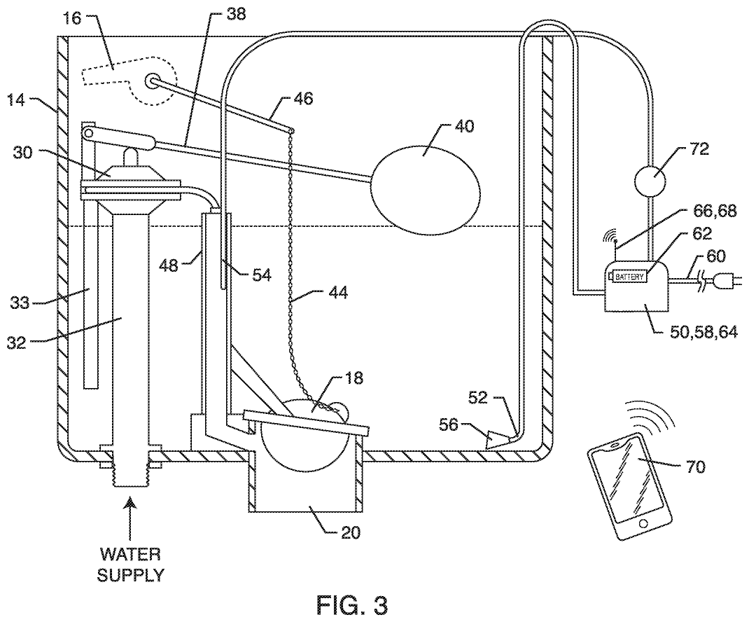

Turning now to FIGS. 3-9, this disclosure teaches various embodiments of how to create an effective, economical, simple and automated (or on demand) method of creating a controlled flow event or series of events to affect the pressure in a plumbing system. Equipment used in this art does not require professional installation and is capable of either wireless electronic communication or a hardwired electronic communication.

In one of its simplest form, a small submersible fluid pump or regular (non-submersible) fluid pump 50 is used to draw water from a toilet tank in a building and discharge it to the toilet bowl or other drains. By pumping water from the toilet tank, the water level in the tank drops and the toilet fill valve opens to replace the discharged water from the tank by drawing water from the water line. This discharge/re-fill sequencing creates periodic flow in the supply piping. The frequency that toilet fill valve cycles depends on the volume of water that the pump discharges. This can be regulated to the desired level to achieve the desired cycling intervals.

It is noted that the pump discharge rate can be controlled by an inline valve on the delivery (fluid outlet) or suction sides (fluid inlet) of the pump. Alternatively, the pump discharge rate can be controlled by the selection of the size of the pump and/or the voltage applied to the pump.

Dissimilar to leaving a faucet running with a small stream of water, water discharge in this method is intermittent and discharges a larger volume of water (in comparison to a steady stream) at each interval. This surge of water helps move any frozen water along the walls of the pipe forward and can prevent various forms of damage to the piping system of a building. The final product can be in the form described above or any combination of that and/or the other embodiments described herein.

Now referring to FIG. 3, it shows another sectional view of a prior art toilet tank now equipped with one embodiment of the present invention. An electrically-powered fluid pump 50 has a fluid inlet 52 and a fluid outlet 54. The electrically-powered fluid pump 50 is configured to move a fluid (herein water) from the fluid inlet 52 to the fluid outlet 54, whether the inlets and outlets are short or are very long. Here, the fluid inlet 52 can be made from a long and flexible fluid pipe (tubing) that can be routed from the top of the tank to then reside within the tank. Many times a toilet lid (not shown) will have a scalloped bottom such that various small wires and pipes can be routed underneath the toilet lid without being pinched. Alternatively, if the toilet lid does not have such scallops (recesses) for such routing a tank spacer could be used to provide enough relief to run such wires and tubing. To make sure the distal end of the fluid inlet remains below the water level a weight 56 can be attached thereto which keeps the fluid inlet 52 below the water level.

An electronic controller 58 is in electrical communication with the electrically-powered fluid pump. As shown here, the electronic controller is connected to the pump and can be packaged in a single unit. The electronic controller 58 is configured to control the operation of the electrically-powered fluid pump. As is understood by those skilled in the art, the electronic controller may be an electrical board with various electrical components necessary to make it function appropriately.

For example, the electronic controller may be configured to receive a wireless communication from an external electronic device 70. Accordingly, the electronic controller would have a wireless receiver 66 disposed within the electrical board. Optionally, the electronic controller could also have a wireless transmitter 68 such that information could be sent outwardly. These wireless communications could be replaced with a hard line (electronic wire) that also transmits information to the external electronic device 70. Accordingly, the external electronic device 70 may be a desktop computer, a laptop computer, a mobile electronic device, a centralized server or even a temperature sensor.

The electronic controller 50 may receive an electrical power from an electric cord 60 configured to be plugged into an electrical system of the building. Alternatively, the electronic controller may receive the electrical power from a battery (permanent or rechargeable) 62 that is associated with the electronic controller. In either situation, it may be helpful for the electronic controller 50 to also include a speaker/audible alarm 64 that is configured to produce an alarm sound when a low battery condition is detected from the battery. The alarm 64 may also be activated if the electronic controller detects any other fault or a possible malfunctioning condition.

As shown in FIG. 3, one would install the fluid inlet 52 of the electrically-powered fluid pump to be in fluidic communication with the tank of a toilet. This allows the pump 50 to take water from the tank 14. However, there are more options when it comes to locating the fluid outlet 54. The fluid outlet 54 may be in fluidic communication with either: i) the bowl 12 of the toilet, wherein the bowl of the toilet is in fluidic communication with a drainage system of the building; ii) the overflow tube 48 of the tank of the toilet, wherein the overflow tube is in fluidic communication with the bowl of the toilet; or iii) a drain of the piping system of the building, such as a floor, shower or sink drain. A shown in FIG. 3, the fluid outlet 54 is placed within the overflow tube 48. Therefore, when the pump 50 turns on it is able to move the water inside the tank to then flush through the overflow 48 and into the bowl 12. In this way, once the water level in the tank drops far enough, the fill valve 30 will open and the tank will refill.

As can be understood, the electronic controller 50 is configured to repeatedly turn on and off the electrically-powered fluid pump for a predetermined elapsed time or volume displacement when the hydraulic condition is identified. The hydraulic condition may be a potential freezing condition of the piping system of the building. The external electronic device is configured to send the wireless communication to the electronic controller when a local weather condition of the building could result in a potential freezing condition of the piping system. Again, such a weather condition can be recognized by the external electronic device 70.

Alternatively, the hydraulic condition may be an overly high pressure of the piping system of the building. For example, the external electronic device 70 can be a fluid monitoring and control system that includes a pressure sensor, as is taught by the Applicant in application Ser. No. 14/182,213 filed on Feb. 17, 2014 (Pub. No. 2014/0230925), the contents of which are fully incorporated herein with this reference. The external electronic device is configured to monitor a pressure of the piping system and if an overly high pressure is identified, the pump can activate which in turn will cause water to flow in the building's pipe system to therefore relieve such pressure. For example, the present invention can be used to relieve a pressure rise caused by thermal expansion, water hammer, pressure reducing valve bleed-through of main pressure, or for diagnostic purposes for system pressure response.

Also shown in FIG. 3 is an optional fluid valve 72. This valve may be electronically actuated and controlled by the electronic controller 50 or may be manually actuated. Valve 72 can be used to adjust the amount of water that goes to the bowl 12, because sometimes the pump may deliver too much water such that the valve 72 can regulate it. Normally, once the valve 72 is set it, it can stay at the same setting. Therefore, the valve 72 can provide a greater degree of control in various needed circumstances.

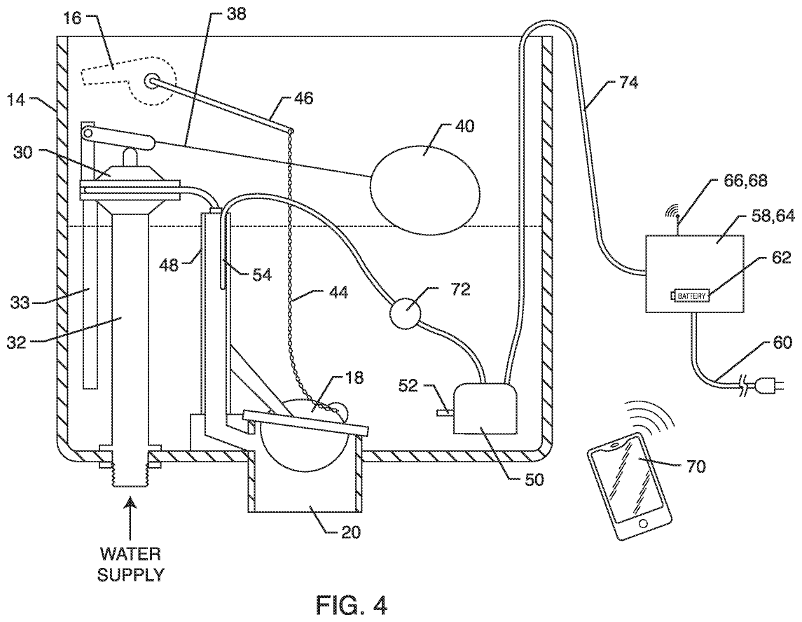

As shown in FIG. 3, the electrically-powered fluid pump is disposed outside the tank of the toilet. However, turning now to FIG. 4 one can see that the electrically-powered fluid pump 50 is configured to be submersible and is disposed within the tank of the toilet. The electronic controller 58 could still be part of the pump 50 and either be sealed in a water proof container or have a water proof conformal coating. However, as shown here the electronic controller 58 is disposed outside of the tank 14 and includes an electrical communication cord 74 for communicating between the controller 58 and the pump 50.

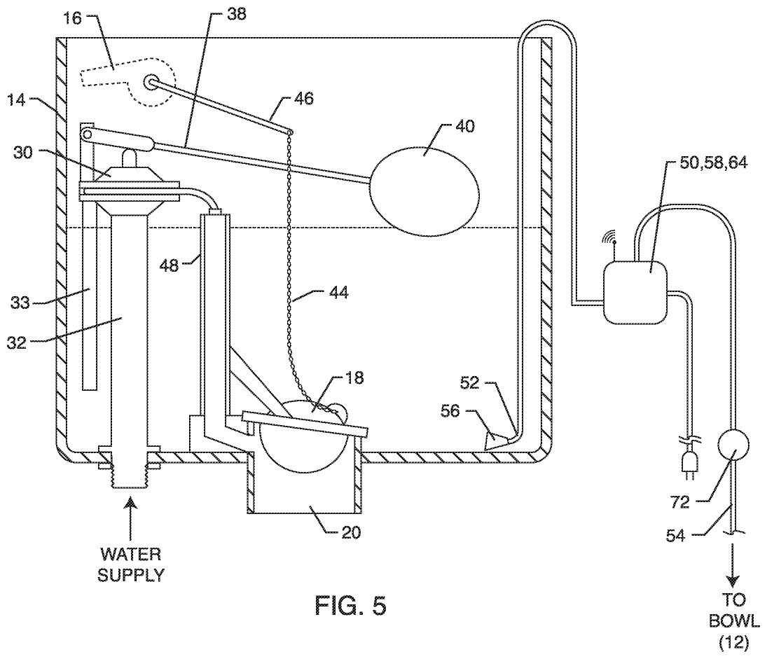

As shown in FIG. 5, the pump 50 and the electronic controller 58 are once again disposed outside of the tank 14, but now the fluid outlet is in fluidic communication with the bowl 12. This can be accomplished by installing a fluid tube that exits into the bowl directly as it does not have to be placed within the overflow tube 48. In either case, the water from the tank can be emptied into the bowl 12 to cause the tank to refill.

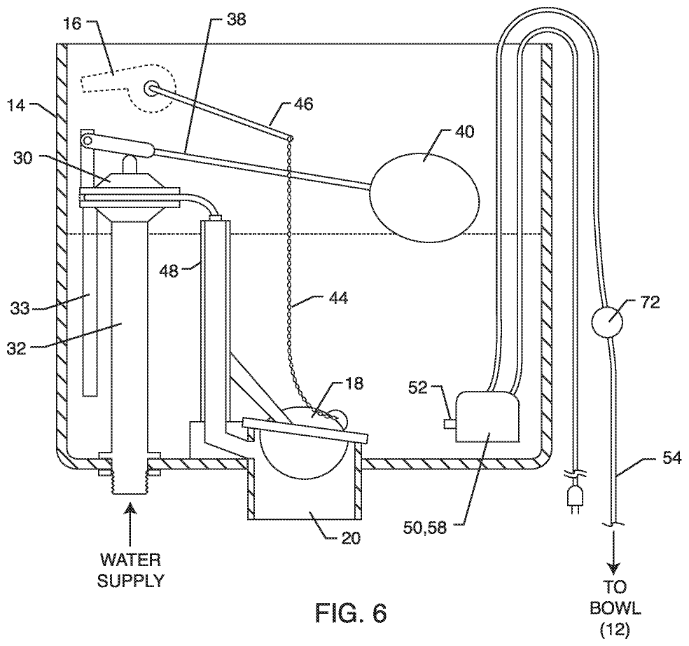

As shown in FIG. 6, the pump 50 is disposed within the tank where now the fluid outlet 54 is again directed to exit into the bowl directly and bypass the overflow tube 48.

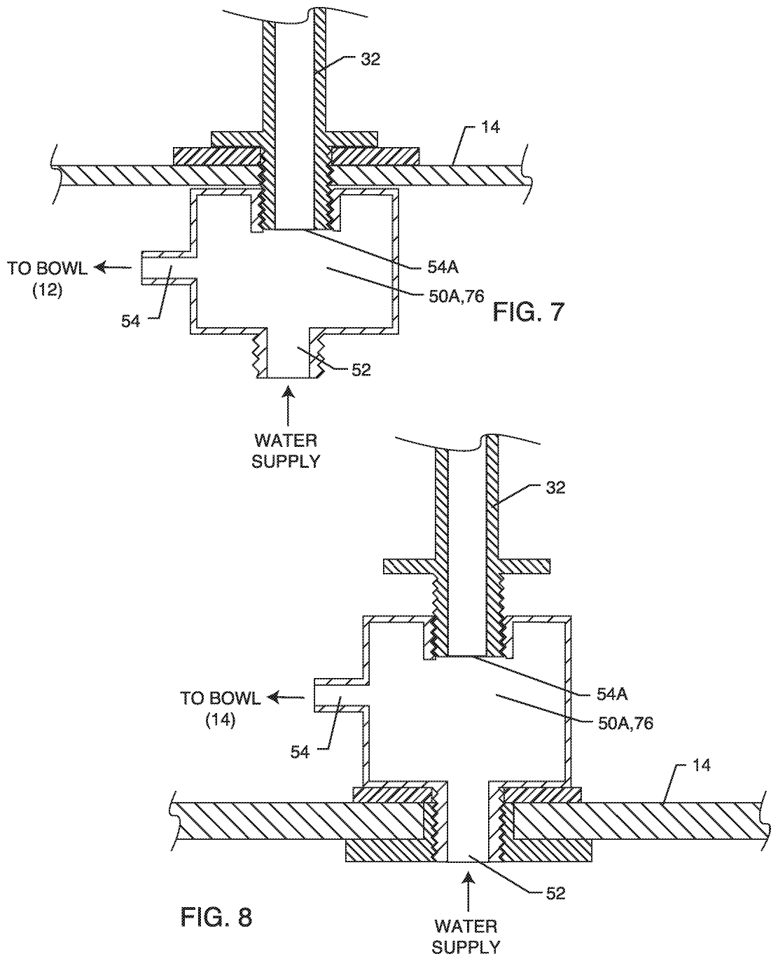

Turning now to FIGS. 7 and 8, in an alternative form of the present invention, rather than using an electrically-controlled fluid pump, now an electrically-controlled fluid valve 50A can be used. The fluid valve 50A is used in a similar as previously discussed embodying all the features of the pump 50. However, the valve 50A is now positioned in series with the water supply from the building's piping system. In FIG. 7, the valve 50A is disposed outside the tank 14. It is understood that the valve 50A can be anywhere along the water supply to the tank. The valve 50A is configured to allow water to enter the fluid inlet and pass unobstructed to the pipe extension 32 and the fill valve 30. However, the valve 50A has a first fluid outlet 54 which can be routed to either: i) the bowl of the toilet, wherein the bowl of the toilet is in fluidic communication with a drainage system of the building; ii) the overflow tube of the tank of the toilet, wherein the overflow tube is in fluidic communication with the bowl of the toilet; or iii) the tank of the toilet, the tank having the overflow tube. As shown in FIG. 7, the outlet 54 is routed to the bowl 12.

It is also noted that the valve 50A has a second fluid outlet 54A. The second fluid outlet 54A is in constant (uninterrupted) fluid communication with the fluid inlet 52 such that water can still flow through the fluid valve 50A between the inlet 52 and the outlet 54A (and the pipe extension 32) such that when the toilet is used in its normal course it can operate as originally designed. Therefore, a valve 76 is disposed within the valve 50A that controls the flow of water out through the fluid outlet 54 and does not control flow out through the second fluid outlet 54A. The valve 76 may be a ball valve or any other suitable fluidic valve.

FIG. 8 shows a very similar design in regards to FIG. 7, but now the valve 50A is disposed within the tank 14. Here, the valve 50A is submersible, but could be disposed higher up and above the water level. Again, the fluid outlet 54 can be routed to the bowl, the tank or to the overflow. As shown here, it is simplistic to just let the outlet 54 flow into the tank such that water will eventually overflow the overflow tube and again drain into the tank.

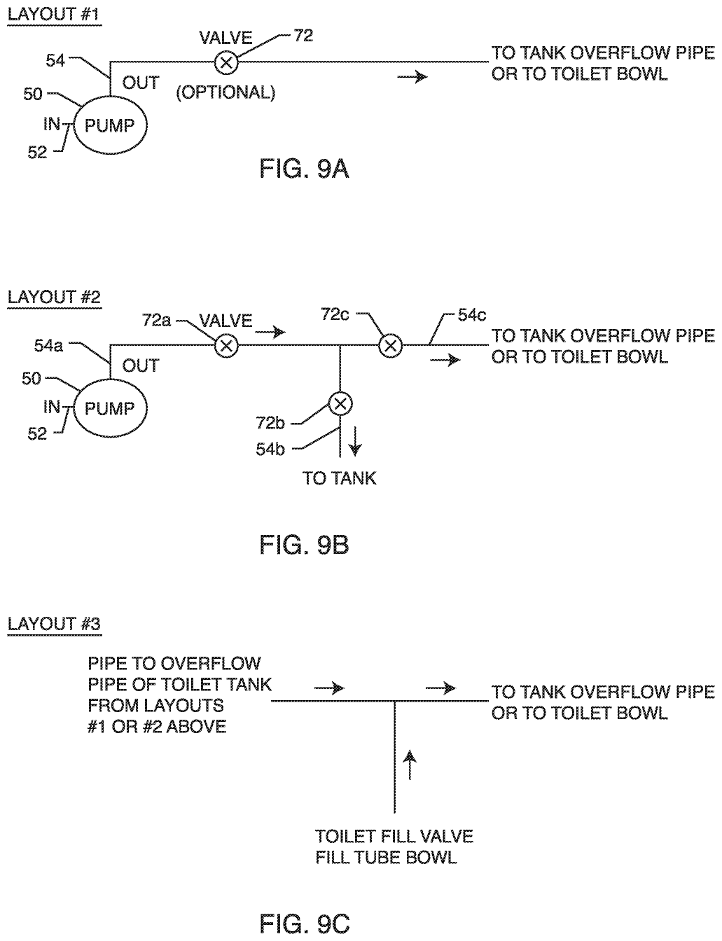

FIGS. 9A-9C show schematically various possible fluid piping flows. For example, in FIG. 9A the pump takes water in at 52 and pushes it out at 54 and through the optional valve 72. Water is then moved to the tank overflow pipe or to the toilet bowl directly.

FIG. 9B shows another variations of FIG. 9A, where now the exit flow can be split, where each portion can also have an optional valve 72. There is a first valve 72a on the main exit line 54a. Then the flow is split into a flow portion 54b having its own valve 72b and also a flow portion 54c having its own valve 72c.

FIG. 9C is a third piping schematic showing that the water flows can be combined. For example, water is moved by the pump 50 from layouts shown in FIGS. 9A and 9C. That flow can then be combined with the flow from the toilet fill valve 30 and fill tube 36. This embodiment would then create a higher overall flow rate by combining the two flows at the same time. As can be understood by those skilled in the art, any of the embodiments taught in FIGS. 9A-C can be used with any of the embodiments taught herein.

FIG. 11 is another embodiment of the present invention showing the device before it is installed into a tank 14. The pump 50 is submersible and is configured to be disposed within the tank 14. However, now a power cord 78 extends to the electronic controller 58. The electronic controller has a bracket 80, where the bracket is configured to hold the electronic controller 58 inside of the tank by attaching to the top of the tank. Many variations of brackets 80 are possible to those skilled in the art, including suction cups or other structures that could be used to mount the electronic controller 58.

The electronic controller now has a fill detection sensor 82. The fill detection sensor 82 can be made from a multitude of types known to those skilled in the art, as this teaching is not limited to this exact form. However, as shown herein, the fill detection sensor 82 comprises a small float (ballcock/float type sensor) at end of a cantilevered arm, where a pivot point of the arm controls the operation of an electronic switch.

The electronic controller 58 has a power cord 84 that is routed to a power adapter 86 that is configured to send the required voltage and amperage to the electronic controller 58. Likewise, an electrical cord 60 is configured to be plugged into a standard electrical wall outlet. As taught previously, the electronic controller 58 could comprise a battery 62 for power.

In this embodiment, the external electronic device is an external temperature sensor 70. The temperature sensor 70 would also have at least a wireless transmitter 68 to send wireless information to the electronic controller 58. Alternatively, the temperature sensor 70 could have a wireless receiver 66. Similarly, the electronic controller 58 has at least a wireless receiver 66, and alternatively could include a wireless transmitter 68, to communicate with the temperature sensor 70.

The fluid outlet 54 of the pump can be various lengths of flexible tubing and includes a clip 88 at its distal end that allows it to be easily attached to the overflow tube 48 as seen in FIG. 11. This way the fluid outlet 54 will move water into the overflow tube 48 which in turn flows to the bowl 12.

Additionally, either fluid outlet 54 or the clip 88 has an additional sensor 90, which is a water flow sensor. This sensor 90 can be electrically routed by wire 92 to the pump and in turn to the electronic controller 58, or be wired directly to the electronic controller 58. The sensor 90 is configured to detect the presence of water in the fill tube 36. The sensor 90 is made of a conductive material and when powered by the microcontroller creates a charged electric field that changes when water is near the sensor. Alternatively, the sensor 90 could also be made as a separate device that is not part of the fluid outlet 54. The sensor 90 could be simply attached to a portion of the fill tube 36 to sense when water was moving there through.

Alternatively, an additional sensor 90, 82 or the like may be placed inside the bowl of the toilet to protect against flooding by the toilet bowl water overflowing due to a blockage in the draining system.

Referring to FIG. 11, it is noted that the toilet mechanisms disposed within the tank 14 are a different version from the prior art versions shown in FIGS. 1 and 2. These various toilet mechanisms are also known to those skilled in the art and does not impact the use and structure of the present invention, as the present inventions works the same way regardless of the toilet mechanisms disposed within the tank 14. It is also noted that the flapper valve 18 and inlet 20 to the bowl 12 has not been shown for simplicity, but in reality would exist in the tank 14.

There are many advantages of having a fill detection sensor 82 and a water flow sensor 90. If one was to flush the toilet, the present invention can take this into account because it can detect a flush. One is also able to determine the rate of water filling the tank, such that calculations can be based on how frequently one needs to empty the toilet tank to reduce the hydraulic condition that may be present.

The flow sensor 90 provides more precise ability to measure and control the flow events of the toilet fill valve 30. In application of the base concept to use the pump 50 to displace water from the tank to include a flush event there is a limitation where each fill valve 30 will respond differently relative to the volume displaced before starting a refill cycle. Control logic applies pump flow rate and duty cycle modulation to create a series of fill valve refill/flow events over a specific time interval. The count and frequency can be increased by increasing pump flow rate and duty cycle as temperature decreases.

In another embodiment, if the device of the present invention is coupled to an external flow sensor (i.e. the applicant's other device disclosed in the '213 application) there can be feedback relative to the actual flow rate. The fill detection sensor 82 is a simpler, integrated alternative to relying on a discrete flow meter signal. Instead of using existing pump speed and duty cycle modulation, the fill sensor 82 allows binary control logic for pump 50. The pump 50 is turned on and a timer is started. The pump 50 can run until the fill detection sensor 82 detects flow going from the toilet fill valve to overflow fill tube 48. The pump 50 is turned off at that point and timer stopped. Knowing flow rate of the pump 50 and the duration of pump's on time gives one the ability to quantify the volume of water for that specific toilet/fill valve combination.

Furthermore, property and plumbing system information provided by property owner (square footage, pipe diameter, pipe material, etc.) can provide those skilled in the art with an idea as to approximate volume of water in the piping system. For a typical 2,000 square foot home with ¾″ copper tubing one skilled in the art could estimate the volume of water in the system to be 3 to 6 gallons. To reduce risk of a pipe freezing, the objective is to achieve a complete purging of that volume within a specific time frame which is variable based upon ambient temperature reading from remote temperature sensor. Application of this knowledge with the event feedback in control logic will allow system purging in a most conservative manner such that not too much water is consumed/wasted.

Regarding the application/event case for the hydraulic condition of a pressure regulation, in most cases the volume of water displaced to trigger the fill valve response is a fraction of that from a standard flush. With flow feedback of the present invention, one is able to regulate the control of one fill valve cycle to drop the pressure. One skilled in the art could program pump 50 to achieve the gpf (gallons per flush) value of the toilet (in an optimum case). For example, on a 1.6 gpf toilet with the Applicant's approach, one could consume 1.6 gallons of a ‘pumped’ volume to guarantee a fill valve cycle. With flow feedback that volume could be reduced to 0.3 to 0.4 gallons.

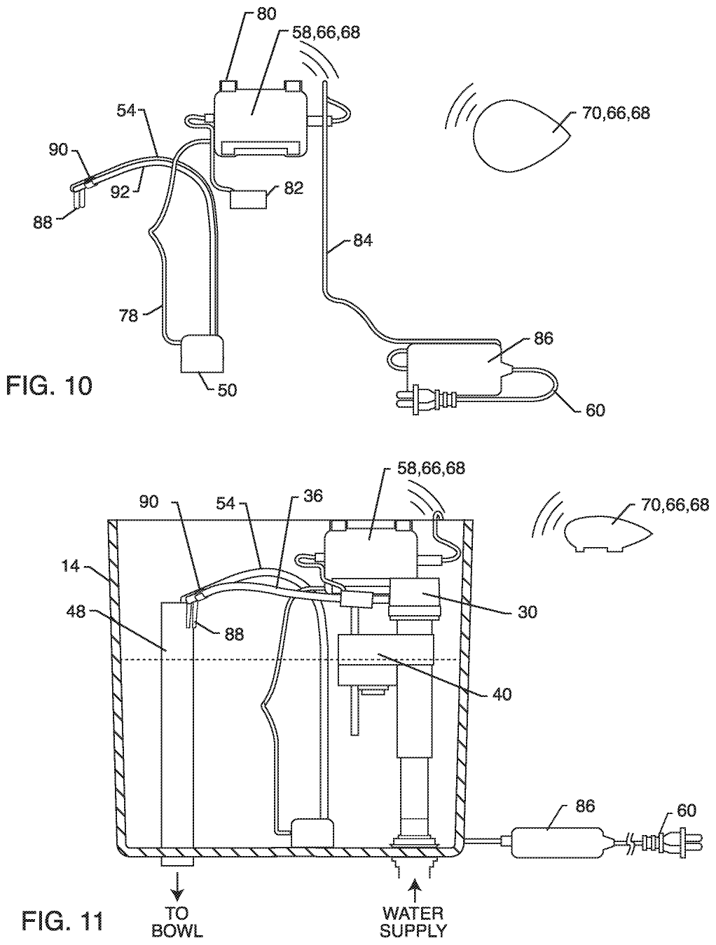

Even though the embodiment in FIGS. 10 and 11 is directed to a pump, it is understood that same teachings can be applied to the electrically-controlled fluid valve as taught herein.

As taught herein, it is understood that the pump 50/valve 50A can be cycled on and off. Therefore, there is a first elapsed time that is the time for which the pump/valve is kept on. For example, if the pump/valve is kept on the toilet may flush and but keep filling as water is being moved from the tank into the bowl and out through the drainage system. This means a water flow can be kept moving indefinitely as needed based on the various hydraulic conditions present.

Secondarily, there is also a second elapsed time between which the pump/valve is activated, in other words, how often the pump/valve is being activated. For example, the pump/valve may be activated every hour, every half hour, every 15 minutes, every 5 minutes or the like dependent upon the various hydraulic condition. As can be appreciated, activating the pump/valve repeatedly may also be needed during various extreme hydraulic conditions, such as very cold temperatures that might lead to frozen pipes. Again, all of these calculations are taken into account with the device of the present invention.

In any of the various embodiments, the pump 50/valve 50A duty cycle and schedule can be independently controlled by the external electronic device 70 to further characterize the volume and frequency of flow.

In any of the various embodiments, the pump 50/valve 50A can be controlled by a temperature sensor 70 that is placed outside the building that is in wired or wireless communication with the control.

In any of the various embodiments, the pump 50/valve 50A can be controlled remotely through Wi-Fi, Internet, Cellular communication or other means.

In any of the various embodiments, the pump 50/valve 50A can be directly or remotely controlled by a third-party through remote and or wireless communication.

In any of the various embodiments, the pump 50/valve 50A can be controlled by weather forecast obtained from internet.

In any of the various embodiments, more than one toilet in a building can be equipped with the present invention. These devices can be controlled by separate controllers or by one controller. Control signals between installations can be conducted via direct connection or remotely via wireless communication means.

In any of the various embodiments, a latching-type solenoid valve 50A connected between the inlet side of toilet fill valve and toilet overflow tube is pulsed open to relieve pressure caused by thermal expansion.

In any of the various embodiments, temperature or pressure telemetry can be provided via other smart devices within the premises that connect via local-communication or cloud infrastructure.

In any of the various embodiments, the pump 50/valve 50A operating state can be determined remotely via mobile application or web site interface.

In any of the various embodiments, the pump 50/valve 50A operation can be controlled remotely via mobile application or web site interface.

In any of the various embodiments, the pump 50/valve 50A is connected to an intermediate tank within or outside the main toilet tank, wherein intermediate tank contains media for treatment of main bowl residual water for sanitation and odor-remediation purpose.

In any of the embodiments disclosed herein, an alternative form of electrical energy may be harvested from either the water coming into the tank of the toilet or when water exits the tank of the toilet. This can be accomplished with a turbine that is rotated as water moves past it. The turbine then turns an electrical generator which can be stored in the battery 62.

As used herein, the use of “hydraulic” relates to a liquid moving in a confined space under pressure. More specifically, the fluid referred to herein is water which is used throughout various building structures, such as the water supplied to faucets, showers, sinks, sprinkler, toilets and the like.

Although several embodiments have been described in detail for purposes of illustration, various modifications may be made to each without departing from the scope and spirit of the invention. Accordingly, the invention is not to be limited, except as by the appended claims.

What is claimed is:

1. A method of generating a controlled flow event of a piping system of a building to regulate a hydraulic condition of the piping system, the method comprising the steps of:
providing an electrically-powered fluid pump having a fluid inlet and a fluid outlet, the electrically-powered fluid pump configured to move a fluid from the fluid inlet to the fluid outlet;
providing an electronic controller in electrical communication with the electrically-powered fluid pump, the electronic controller configured to control the operation of the electrically-powered fluid pump, wherein the electronic controller receives an electrical power from an electric cord configured to be plugged into an electrical system of the building, or, wherein the electronic controller receives the electrical power from a battery that is associated with the electronic controller;
installing the fluid inlet of the electrically-powered fluid pump to be in fluidic communication with a tank of a toilet; and
installing the fluid outlet of the electrically-powered fluid pump to be in fluidic communication with either:
i) a bowl of the toilet, wherein the bowl of the toilet is in fluidic communication with a drainage system of the building;
ii) an overflow tube of the tank of the toilet, wherein the overflow tube is in fluidic communication with the bowl of the toilet; or
iii) a drain of the piping system of the building;
wherein the electronic controller is configured to repeatedly turn on and off the electrically-powered fluid pump to run for a predetermined elapsed time or volume displacement when the hydraulic condition is identified.

2. The method of claim 1, wherein the hydraulic condition is a potential freezing condition of the piping system of the building.

3. The method of claim 1, wherein the hydraulic condition is an overly high pressure of the piping system of the building.

4. The method of claim 1, wherein the electronic controller is configured to receive a wireless communication from an external electronic device.

5. The method of claim 4, wherein the external electronic device is a desktop computer, a laptop computer, a mobile electronic device, a centralized server or a temperature sensor.

6. The method of claim 5, wherein the external electronic device is configured to send the wireless communication to the electronic controller when a local weather condition of the building could result in a potential freezing condition of the piping system.

7. The method of claim 4, wherein the external electronic device is configured to monitor a pressure of the piping system.

8. The method of claim 7, wherein the external electronic device is configured to send the wireless communication to the electronic controller when the hydraulic condition is an overly high pressure of the piping system of the building.

9. The method of claim 1, wherein the electronic controller includes and is in electrical communication with an audible alarm configured to produce an alarm sound when a low battery condition is detected from the battery.

10. The method of claim 1, wherein the electrically-powered fluid pump is configured to be submersible and is disposed within the tank of the toilet.

11. The method of claim 1, wherein the electrically-powered fluid pump is disposed outside the tank of the toilet.

12. A method of generating a controlled flow event of a piping system of a building to regulate a hydraulic condition of the piping system, the method comprising the steps of:
providing an electrically-controlled fluid valve having a fluid inlet, a first fluid outlet and a second fluid outlet, wherein the fluid inlet is configured to be fluidic communication with a fluid supply of the piping system of the building, and wherein a valve disposed within the fluid valve controls the flow to the first fluid inlet, and wherein the second fluid outlet is configured to be constant fluid communication with the fluid inlet;
providing an electronic controller in electrical communication with the electrically-controlled fluid valve, the electronic controller configured to control the operation of the electrically-controlled fluid valve, wherein the electronic controller receives an electrical power from an electric cord configured to be plugged into an electrical system of the building, or, wherein the electronic controller receives the electrical power from a battery that is associated with the electronic controller;
installing the fluid inlet of the electrically-controlled fluid valve to be in fluidic communication with the fluid supply of the piping system of the building; and
installing the fluid outlet of the electrically-powered fluid valve to be in fluidic communication with either:
i) a bowl of the toilet, wherein the bowl of the toilet is in fluidic communication with a drainage system of the building;
ii) an overflow tube of the tank of the toilet, wherein the overflow tube is in fluidic communication with the bowl of the toilet;
iii) the tank of the toilet, the tank having the overflow tube; or
iv) a drain of the piping system of the building;
wherein the electronic controller is configured to repeatedly turn on and off the electrically-controlled fluid valve for a predetermined elapsed time or volume displacement when the hydraulic condition is identified.

13. The method of claim 12, wherein the hydraulic condition is a potential freezing condition of the piping system of the building, or, wherein the hydraulic condition is an overly high pressure of the piping system of the building.

14. The method of claim 12, wherein the electronic controller is configured to receive a wireless communication from an external electronic device, wherein the external electronic device is a desktop computer, a laptop computer, a mobile electronic device, a centralized server or a temperature sensor.

15. The method of claim 14, wherein the external electronic device is configured to send the wireless communication to the electronic controller when a local weather condition of the building could result in a potential freezing condition of the piping system.

16. The method of claim 14, wherein the external electronic device is configured to monitor a pressure of the piping system, wherein the external electronic device is configured to send the wireless communication to the electronic controller when the hydraulic condition is an overly high pressure of the piping system of the building.

17. A device for generating a controlled flow event of a piping system of a building to regulate a hydraulic condition of the piping system, the device comprising:
an electrically-powered fluid pump having a fluid inlet and a fluid outlet, the electrically-powered fluid pump configured to move a fluid from the fluid inlet to the fluid outlet;
wherein the fluid inlet of the electrically-powered fluid pump is configured to be in fluidic communication with a tank of a toilet;
wherein the fluid outlet of the electrically-powered fluid pump is configured to be in fluidic communication with either:
i) a bowl of the toilet, wherein the bowl of the toilet is in fluidic communication with a drainage system of the building;
ii) an overflow tube of the tank of the toilet, wherein the overflow tube is in fluidic communication with the bowl of the toilet; or
iii) a drain of the piping system of the building;
an electronic controller in electrical communication with the electrically-powered fluid pump, the electronic controller configured to control the operation of the electrically-powered fluid pump;
wherein the electronic controller is configured to receive an electrical power from an electric cord configured to be plugged into an electrical system of the building, or, wherein the electronic controller is configured to receive the electrical power from a battery that is associated with the electronic controller;
wherein the electronic controller is configured to repeatedly turn on and off the electrically-powered fluid pump for a predetermined elapsed time or volume displacement when the hydraulic condition is identified.

18. The device of claim 17, wherein the electronic controller is configured to receive a wireless communication from an external electronic device, wherein the external electronic device is a desktop computer, a laptop computer, a mobile electronic device, a centralized server or a temperature sensor.

19. The device of claim 18, wherein the external electronic device is configured to send the wireless communication to the electronic controller when a local weather condition of the building could result in a potential freezing condition of the piping system.

20. The device of claim 19, wherein the external electronic device is configured to monitor a pressure of the piping system, wherein the external electronic device is configured to send the wireless communication to the electronic controller when the hydraulic condition is an overly high pressure of the piping system of the building.

21. The device of claim 17, wherein the electronic controller includes a fill detection sensor configured to monitor a height of the fluid in the tank.

22. The device of claim 17, including a water flow sensor in electrical communication with the electronic controller, wherein the water flow sensor is configured to determine a water flow in a fill tube for the overflow tube of the toilet.

23. A device for generating a controlled flow event of a piping system of a building to regulate a hydraulic condition of the piping system, the device comprising:
an electrically-controlled fluid valve having a fluid inlet, a first fluid outlet and a second fluid outlet;
wherein a valve disposed within the electrically-controlled fluid valve controls the fluid flow to the first fluid inlet;
wherein the second fluid outlet is configured to be constant fluid communication with the fluid inlet;
wherein the first fluid inlet is configured to installed to be in fluidic communication with a fluid supply of the piping system of the building;
wherein the first fluid outlet of the electrically-powered fluid valve is configured to be installed to be in fluidic communication with either:
i) a bowl of the toilet, wherein the bowl of the toilet is in fluidic communication with a drainage system of the building;
ii) an overflow tube of the tank of the toilet, wherein the overflow tube is in fluidic communication with the bowl of the toilet;
iii) the tank of the toilet, the tank having the overflow tube; or
iv) a drain of the piping system of the building;
an electronic controller in electrical communication with the electrically-controlled fluid valve, the electronic controller configured to control the operation of the electrically-controlled fluid valve;
wherein the electronic controller is configured to receive an electrical power from an electric cord configured to be plugged into an electrical system of the building, or, wherein the electronic controller is configured to receive the electrical power from a battery that is associated with the electronic controller;
wherein the electronic controller is configured to repeatedly turn on and off the electrically-controlled fluid valve for a predetermined elapsed time or volume displacement when the hydraulic condition is identified.

24. The device of claim 23, wherein the electronic controller is configured to receive a wireless communication from an external electronic device, wherein the external electronic device is a desktop computer, a laptop computer, a mobile electronic device, a centralized server or a temperature sensor.

25. The method of claim 24, wherein the external electronic device is configured to send the wireless communication to the electronic controller when a local weather condition of the building could result in a potential freezing condition of the piping system.

26. The method of claim 25, wherein the external electronic device is configured to monitor a pressure of the piping system, wherein the external electronic device is configured to send the wireless communication to the electronic controller when the hydraulic condition is an overly high pressure of the piping system of the building.
